(19) United States
(12) Patent Application Publication
(10) Pub. No.: US 2011/0242093 A1
(43) Pub. Date: Oct. 6, 2011

(54) APPARATUS AND METHOD FOR PROVIDING IMAGE DATA IN IMAGE SYSTEM

(75) Inventors: Kwanghee JUNG, Gyeonggi-do (KR); Kug-Jin YUN, Daejeon (KR); Bong-Ho LEE, Daejeon (KR); Gwang-Soon LEE, Daejeon (KR); Hyun LEE, Daejeon (KR); Namho HUR, Daejeon (KR); Jin-Woong KIM, Daejeon (KR); Soo-In LEE, Daejeon (KR)

(73) Assignee: Electronics and Telecommunications Research Institute, Daejeon (KR)

(21) Appl. No.: 12/958,857

(22) Filed: Dec. 2, 2010

(30) Foreign Application Priority Data
Mar. 31, 2010 (KR) 10-2010-0029584

(51) Int. Cl. G06T 15/00

(52) U.S. Cl. 345/419

(57) ABSTRACT

An apparatus for providing image data in an image system includes: a stereoscopic image generation unit configured to receive image data and depth information data and generate stereoscopic image data; a parallax calculation unit configured to analyze parallax information of a 3D image from the stereoscopic image data, divide the analyzed parallax information step by step, and determine parallax step information; a caption and text generation unit configured to generate a caption and a text by applying the parallax step information and generate position information of the generated caption and text; and an image synthesis unit configured to insert the caption and text into the stereoscopic image data based on the position information of the caption and text and provide 3D image data.

### CROSS-REFERENCE(S) TO RELATED APPLICATIONS

The present application claims priority of Korean Patent Application No. 10-2010-0029584, filed on Mar. 31, 2010, which is incorporated herein by reference in its entirety.

### BACKGROUND OF THE INVENTION

1. Field of the Invention

Exemplary embodiments of the present invention relate to an image system; and, more particularly, to an apparatus and a method for inserting captions, texts, and the like into image data according to the user's watching environments and contents characteristics and providing the image data in an image system configured to provide 3D images.

2. Description of Related Art

There has been increasing interest in 3D images provided in image systems, and extensive research is in progress to provide users with various types of 3D images. As used herein, a 3D image, i.e. stereoscopic image, refers to an image composed in such a manner that, based on depth information, the user is made to feel as if parts of the image come out of the screen. The depth information refers to information regarding the relative distance of an object at a location of a 2D image with regard to a reference location. Such depth information is used to express 2D images as 3D images or create 3D images which provide users with various views and thus realistic experiences.

Various approaches have been proposed to enable users to watch more realistic 3D images. In addition, there are also methods proposed to insert captions, texts, and the like into 3D images according to the user's watching environments and contents characteristics and provide users with them. Specifically, as a method for inserting captions, texts, and the like into 3D images and providing them, it has been proposed to position captions and texts at the foremost part of 3D images based on the maximum depth value of depth images, which corresponds to depth information of 3D images, and providing users with the 3D images.

However, the above-mentioned method of using the maximum depth value of 3D images has a problem in that, depending on contents characteristics, it may fatigue the 3D image watcher. Furthermore, this method is inapplicable to 3D images with no depth information. In addition, respective 3D image watchers feel different levels of depth perception due to difference in their recognition characteristics. Therefore, there is a need for a method for providing 3D images in such a manner that, according to characteristics of 3D image watchers, e.g. watching environments and contents characteristics, the 3D images can be watched selectively.

### SUMMARY OF THE INVENTION

An embodiment of the present invention is directed to an apparatus and a method for providing users with image data in an image system.

Another embodiment of the present invention is directed to an apparatus and a method for inserting captions, texts, and the like into image data according to the user's watching environments and contents characteristics and providing the image data in an image system.

Another embodiment of the present invention is directed to an apparatus and a method for providing image data in an image system, wherein the depth perception of captions, texts, and the like, which are inserted into 3D images, is converted for each user so that the user can watch important features of the 3D images with reduced fatigue of eyes.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for providing image data in an image system includes: a stereoscopic image generation unit configured to receive image data and depth information data and generate stereoscopic image data; a parallax calculation unit configured to analyze parallax information of a 3D image from the stereoscopic image data, divide the analyzed parallax information step by step, and determine parallax step information; a caption and text generation unit configured to generate a caption and a text by applying the parallax step information and generate position information of the generated caption and text; and an image synthesis unit configured to insert the caption and text into the stereoscopic image data based on the position information of the caption and text and provide 3D image data.

In accordance with another embodiment of the present invention, a method for providing image data in an image system includes: receiving left-view image data and right-view image data and 2D image data and depth information data and generating stereoscopic image data; analyzing parallax information of a 3D image from the stereoscopic image data and the depth information data, dividing the analyzed parallax information step by step according to parallax generation distribution by clustering the analyzed parallax information through a clustering algorithm, and determining parallax step information through the step-by-step division; applying a parallax value to a caption and a text inserted into the 3D image using the parallax step information and generating a caption and a text corresponding to a left-view image, a caption and a text corresponding to a right-view image, and position information of the captions and texts through application of the parallax value; and inserting the captions and texts into the stereoscopic image data using a parallax value of the parallax step information as the position information of the captions and texts and providing 3D image data.

### BRIEF DESCRIPTION OF THE DRAWINGS

FIG. 1 illustrates a schematic structure of an apparatus for providing image data in an image system in accordance with an embodiment of the present invention.

FIG. 2 illustrates a schematic structure of a parallax calculation unit of an apparatus for providing image data in an image system in accordance with an embodiment of the present invention.

FIGS. 3 and 4 illustrate schematic operations of a parallax calculation unit of an apparatus for providing image data in an image system in accordance with an embodiment of the present invention.

FIG. 5 illustrates a schematic operating process of an apparatus for providing image data in an image system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes an apparatus and a method for providing image data so that users can watch 3D images in an image system. An embodiment of the present invention proposes an apparatus and a method for providing image data, into which captions, texts, and the like are inserted according to the user's watching environments and contents characteristics in an image system configured to provide 3D images. Specifically, in accordance with an embodiment of the present invention, image data is provide in an image system configured to provide 3D images in such a manner that the depth perception of captions, texts, and the like, which are inserted into 3D images, is converted for each user, who then can watch important features of the 3D images with reduced fatigue of eyes.

In accordance with an embodiment of the present invention, when a user watches 3D contents images such as 3D video images and still images, captions and texts to be inserted into 3D images are selectively or automatically inserted into the 3D images in conformity with the user's watching environments and 3D contents characteristics, and the image data is then provided. In addition, in accordance with an embodiment of the present invention, image data is provided which can be applied to generate 3D images including depth information, as well as stereoscopic images including no depth information. Furthermore, the depth perception of captions, texts, and the like is selective or automatically converted and inserted into images according to the user's selection, so that image data is provided with captions, texts, and the like inserted therein. Specifically, image data is provided so that the user can watch important features of 3D images with reduced fatigue of eyes.

In accordance with an embodiment of the present invention, in the case of a stereoscopic 3D image, the parallax within the image is analyzed to divide the parallax information step by step. In the case of a 3D image using depth information, the depth information is clustered to divide the depth information step by step. The parallax of captions, texts, and the like is determined according to the user's selection or automatically, and image data is provided in conformity with the user's watching environments and recognition characteristics. Furthermore, in accordance with an embodiment of the present invention, important information within 3D images or objects having a parallax larger than that of captions, texts, and the like are analyzed, and the objects are automatically avoided so as to reduce fatigue of eyes which could occur when captions and texts are inserted into 3D images, while enabling the user to watch important features of the images.

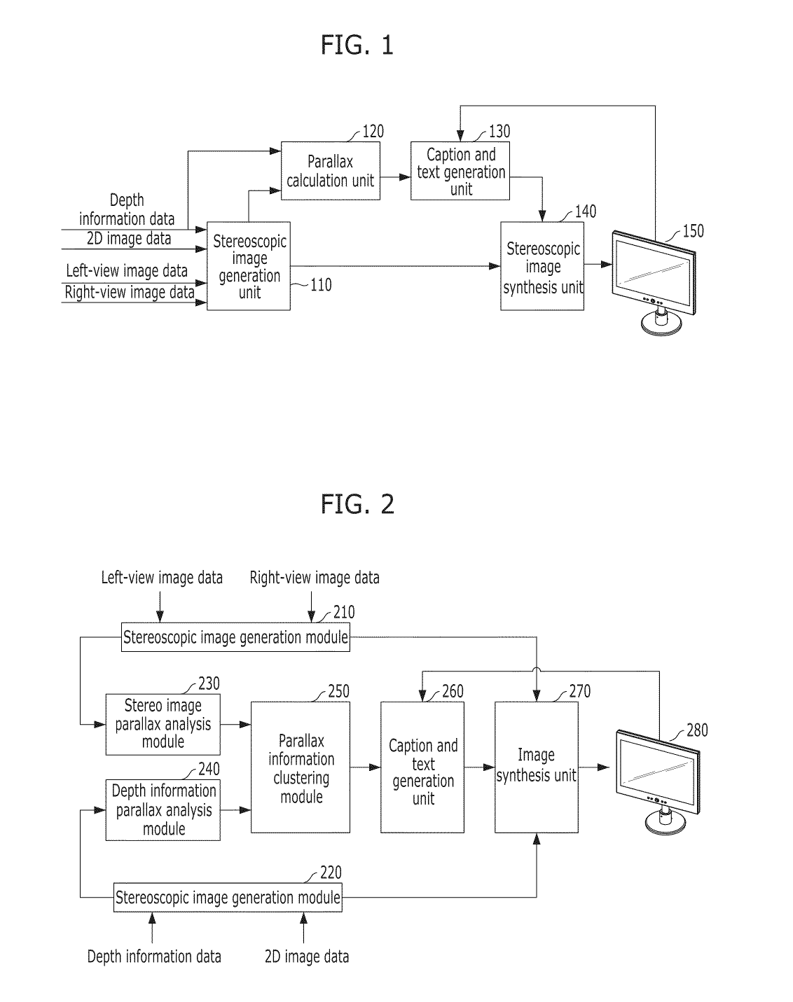

In accordance with an embodiment of the present invention, the problems are solved which occur when the maximum depth value of depth images or the maximum parallax value is used to insert captions and texts at the foremost part of 3D images, and which fatigue the user during watching according to contents characteristics due to use of the maximum depth value, as well as the problems of inability to apply the above-mentioned insertion approach to 3D images having no depth information. In other words, an embodiment of the present invention is applicable not only to generate 3D images including depth information as mentioned above, but also to generate stereoscopic images including no depth information. Furthermore, according to the user's selection, the depth perception of captions and texts is selectively or automatically converted, and they are inserted into images, which are then provided so that the user feels less fatigue which would be severer when watching captions and texts having an excessive parallax. An apparatus for providing image data in an image system in accordance with an embodiment of the present invention will now be described in more detail with reference to FIG. 1.

FIG. 1 illustrates a schematic structure of an apparatus for providing image data in an image system in accordance with an embodiment of the present invention.

Referring to FIG. 1, the apparatus for providing image data includes a stereoscopic image generation unit 110 configured to receive various types of image data and generate stereoscopic image data, a parallax calculation unit 120 configured to analyze parallax information of stereoscopic images, i.e. 3D images, corresponding to the generated stereoscopic image data, a caption and text generation unit 130 configured to generate captions and texts, which are to be inserted into the stereoscopic images, using the parallax information, an image synthesis unit 140 configured to insert captions and texts into the stereoscopic images, and a display unit 150 configured to receive stereoscopic image, i.e. 3D images, into which captions and texts have been inserted, and display the 3D images.

An input signal inputted to the apparatus for providing image data is, when left-view and right-view images are used, stereoscopic image data generated by using left-view image data and right-view image data and, when 2D image data and depth information (e.g. depth image) are used, is depth information data. In accordance with an embodiment of the present invention, when the above-mentioned input signal is inputted to the apparatus for providing image data, 3D image data is processed through a conventional 3D image data generation scheme. The apparatus for providing image data in accordance with an embodiment of the present invention is applicable to any field related to 3D broadcasting and 3D imaging, and can be applied and implemented in a transmission system or, in the case of a system capable of transmitting caption and text information, in a reception terminal.

The stereoscopic image generation unit 110 is configured to generate stereoscopic image data using left-view image data and right-view image data, or 2D image data and depth information data. Specifically, the stereoscopic image generation unit 110 supports both a scheme of synthesizing left-view and right-view images, and a scheme of generating stereoscopic images using depth information. Therefore, the stereoscopic image generation unit 110 generates stereoscopic image data by synthesizing received left-view and right-view image data, or by using 2D image data and depth information data.

The parallax calculation unit 120 is configured to receive stereoscopic image data, which has been generated by the stereoscopic image generation unit 110, or the depth information data, analyze parallax information of stereoscopic images from the stereoscopic image data or the depth information data, and determine parallax step information by dividing the analyzed parallax information step by step. Specifically, the parallax calculation unit 120 divides the parallax information step by step according to parallax generation distribution, and steps of the parallax information may be adjusted by the system or at the request of the user and system designer.

The caption and text generation unit 130 is configured to receive parallax step information, which has been divided and determined by the parallax calculation unit 120, apply a parallax value to captions and texts, which are to be inserted into stereoscopic images, using the parallax step information, and generate captions and texts corresponding to left-view images, as well as captions and texts corresponding to right-view images, through application of the parallax value. In this case, the parallax value may be automatically set by the caption and text generation unit 130 using the parallax step information, or a setting determined by default during system design may be used. Alternatively, the parallax value is adjusted by the user's selection inputted through a 3D terminal.

Furthermore, the caption and text generation unit 130 is configured to designate the insertion position of captions and texts inserted into stereoscopic images, identify important objects or information within stereoscopic images (simply referred to as objects) based on parallax information analyzed by the parallax calculation unit 120, and automatically modify the insertion position information so that the objects are avoided when inserting captions and texts. The caption and text generation unit 130 is also configured to receive caption and text parallax correction information, which is based on the user's watching environments, from the display unit 150, i.e. user terminal, generate captions and texts so that the captions and texts are inserted into stereoscopic images by considering the received caption and text parallax correction information, and designate the insertion position of the generated captions and texts.

The image synthesis unit 140 is configured to insert captions and texts, which have been generated by the caption and text generation unit 130, into stereoscopic images generated by the stereoscopic image generation unit 110. In this case, the image synthesis unit 140 uses the parallax value of parallax step information, which has been determined by the parallax calculation unit 120, as position information of captions and texts inserted into the stereoscopic images. It is also possible to insert captions and texts in a default preset position or in an arbitrary position at the request of the terminal, i.e. the user.

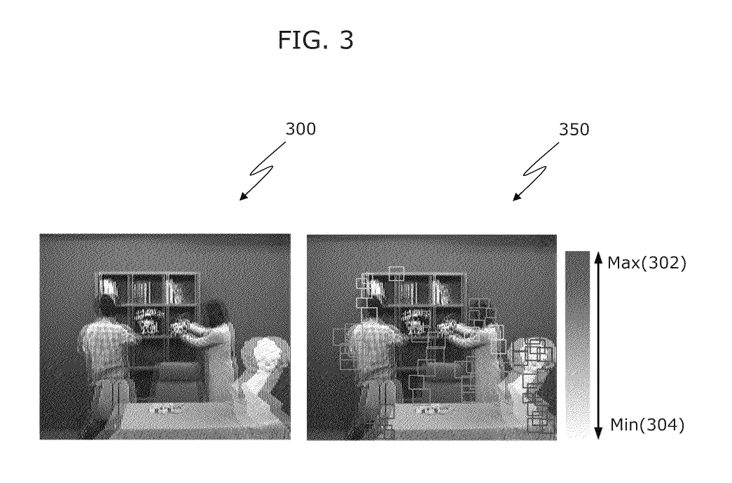

The display unit 150, which is a terminal used to watch stereoscopic images, is configured to receive stereoscopic images, i.e. 3D image data, into which captions and texts have been inserted, from the image synthesis unit 140 and display the 3D images. The parallax calculation unit 120 of the apparatus for providing image data in accordance with an embodiment of the present invention will now be described in more detail with reference to FIG. 2.

FIG. 2 illustrates a schematic structure of a parallax calculation unit of an apparatus for providing image data in an image system in accordance with an embodiment of the present invention.

Referring to FIG. 2, the stereoscopic image generation unit 110 of the apparatus for providing image data has stereoscopic image generation modules 210 and 220 configured to receive left-view image data and right-view image data, or 2D image data and depth information data. More specifically, the stereoscopic image generation modules 210 and 220 are configured to generate stereoscopic image data using left-view image data and right-view image data and transmit the generated stereoscopic image data to a stereo image parallax analysis module 230 and an image synthesis unit 270 of the parallax calculation unit 120. The stereoscopic image generation modules 210 and 220 are also configured to generate stereoscopic image data using 2D image data and depth information data, transmit the generated stereoscopic image data to the image synthesis unit 140, and transmit the depth information data to a depth information parallax analysis module 240 of the parallax calculation unit 120.

The stereo image parallax analysis module 230 of the parallax calculation unit 120 is configured to receive stereoscopic image data from the stereoscopic image generation module 210 and analyze parallax information of stereoscopic images from the received stereoscopic image data. The depth information parallax analysis module 240 of the parallax calculation unit 120 is configured to receive the depth information data and analyze parallax information of stereoscopic images from the received depth information data.

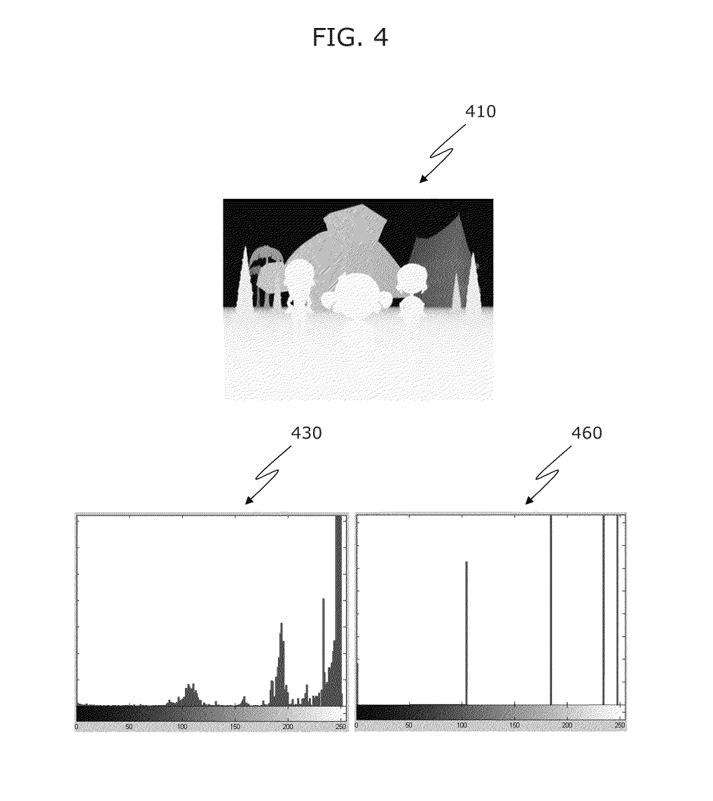

After the stereo image parallax analysis module 230 and the depth information parallax analysis module 240 analyze parallax information of stereoscopic images in this manner, the parallax information clustering module 250 of the parallax calculation unit 120 receives the analyzed parallax information of stereoscopic images and divides the analyzed parallax information of stereoscopic images step by step using a clustering algorithm. Specifically, the parallax information clustering module 250 divides the analyzed parallax information of stereoscopic images step by step according parallax generation distribution, and adjusts the clustering step or range according to system performance or at the request of the user and system designer. The operation of the parallax calculation unit 120 of the apparatus for providing image data in an image system in accordance with an embodiment of the present invention will now be described in more detail with reference to FIGS. 3 and 4.

FIGS. 3 and 4 illustrate schematic operations of a parallax calculation unit of an apparatus for providing image data in an image system in accordance with an embodiment of the present invention.

Referring to FIGS. 3 and 4, the stereoscopic image parallax analysis module 230 of the parallax calculation unit 120 receives stereoscopic image data 300 from the stereoscopic image generation module 210, and analyzes parallax information of stereoscopic images from the received stereoscopic image data 300. The parallax information clustering module 250 then clusters the parallax information 350 of stereoscopic images, which has been analyzed from the maximum parallax value (Max) 302 to the minimum parallax value (Min) 304, using a clustering algorithm.

In addition, the depth information parallax analysis module 240 of the parallax calculation unit 120 receives depth information data 410 and analyzes parallax information 430 of stereoscopic images from the received depth information data 410. The parallax information clustering module 250 clusters the analyzed parallax information 430 of stereoscopic images using a clustering algorithm. The clustered parallax information 430 of stereoscopic images is divided step by step, and the divided parallax information 460 is transmitted to the caption and text generation unit 260.

Each of the parallax information 350 and 430 of stereoscopic images analyzed by the stereoscopic image parallax analysis module 230 and the depth information parallax analysis module 240 of the parallax calculation unit 120 has various values distributed over a large area. The parallax information clustering module 250 of the parallax calculation unit 120 clusters the deviation of the distributed parallax information 350 and 430 of stereoscopic images and divides it into steps of major parallaxes. In other words, the parallax information clustering module 250 clusters 460 the parallax information 350 and 430, which is the result of analysis by the stereoscopic image parallax analysis module 230 and the depth information parallax analysis module 240, so that the caption and text generation unit 260 can insert captions and texts at a step perceivable by the stereoscopic image watcher.

The caption and text generation unit 260 receives parallax steps calculated by the parallax calculation unit 120, i.e. parallax step information resulting from clustering by the parallax information clustering module 250 of the parallax calculation unit 120, and generates a parallax of captions and texts using the received parallax step information. Specifically, the caption and text generation unit 260 generates captions and texts, which are to be inserted into stereoscopic images, using position information predetermined in the image system, i.e. pixel information, text font size information, and parallax information. The caption and text generation unit 260 updates default settings of captions and texts, such as the pixel information, text font size information, and parallax information at the request of the user of the display unit 280 (i.e. terminal) and the system.

When captions and texts to be inserted into stereoscopic images have a parallax above a predetermined maximum parallax value, the caption and text generation unit 260 sets the parallax of captions and texts to be inserted into stereoscopic images as the predetermined maximum parallax value, and can automatically designate the insertion position of captions and texts in stereoscopic images so as to avoid predetermined important object parts within 3D images, as well as areas above the maximum parallax value of the captions and texts.

The image synthesis unit 270 synthesizes stereoscopic images, captions, and texts using captions and texts generated by the caption and text generation unit 260, and position information of the captions and texts.

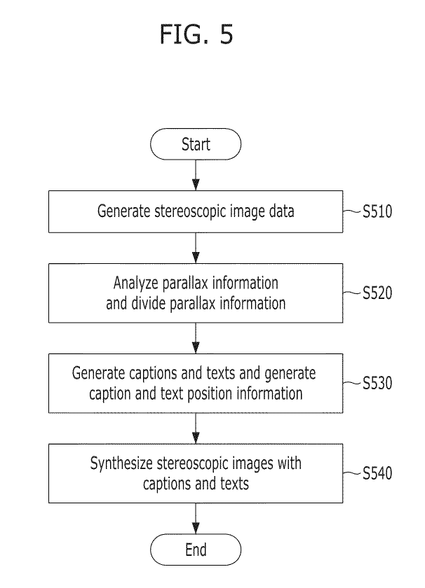

Stereoscopic images thus synthesized by the image synthesis unit 270 are displayed to the user through the display unit 280, i.e. terminal. The caption and text generation unit 260 receives caption and text parallax correction information, which is based on the stereoscopic image watcher's watching environments, from the display unit 280 and considers the received caption and text parallax correction information when generating captions and texts to be inserted into stereoscopic images and designating the insertion position of the captions and texts, as mentioned above. In other words, the caption and text generation unit 260 generates captions and texts and position information of the captions and texts by considering the received caption and text parallax correction information. The operation of providing image data by an apparatus for providing image data in an image system in accordance with an embodiment of the present invention will now be described in more detail with reference to FIG. 5.

FIG. 5 illustrates a schematic operating process of an apparatus for providing image data in an image system in accordance with an embodiment of the present invention.

Referring to FIG. 5, the apparatus for providing image data receives left-view image data and right-view image data, or 2D image data and depth information data and generates stereoscopic image data using the received left-view image data and right-view image data or the 2D image data and depth information data at step S510.

The apparatus analyzes parallax information of stereoscopic images from the generated stereoscopic image data or the depth information data and divides the analyzed parallax information step by step at step S520.

The apparatus applies a parallax value to captions and texts, which are to be inserted into stereoscopic images, using the divided and determined parallax step information, generates captions and texts corresponding to left-view images, as well as captions and texts corresponding to right-view images, through application of the parallax value, and generates position information of captions and texts by designating the position of the generated captions and texts in stereoscopic images at step S530.

The apparatus inserts captions and texts into stereoscopic images using the position information of the captions and texts, and provides the synthesized image data so that the user can watch stereoscopic images at step S540.

In accordance with the exemplary embodiments of the present invention, captions, texts, and the like are inserted into 3D images according to the user's watching environments and contents characteristics, and the user is provided with the 3D images to watch them in an image system. Furthermore, the depth perception of captions, texts, and the like, which are inserted into 3D images, is converted for each user before the insertion so that the user can watch important features of 3D images with reduced fatigue of eyes.

While the present invention has been described with respect to the specific embodiments, it will be apparent to those skilled in the art that various changes and modifications may be made without departing from the spirit and scope of the invention as defined in the following claims.

What is claimed is:

1. An apparatus for providing image data in an image system, comprising:
a stereoscopic image generation unit configured to receive image data and depth information data and generate stereoscopic image data;
a parallax calculation unit configured to analyze parallax information of a 3D image from the stereoscopic image data, divide the analyzed parallax information step by step, and determine parallax step information;
a caption and text generation unit configured to generate a caption and a text by applying the parallax step information and generate position information of the generated caption and text; and
an image synthesis unit configured to insert the caption and text into the stereoscopic image data based on the position information of the caption and text and provide 3D image data.

2. The apparatus of claim 1, wherein the stereoscopic image generation unit comprises a stereoscopic image generation module configured to receive left-view image data and right-view image data and generate the stereoscopic image data.

3. The apparatus of claim 2, wherein the stereoscopic image generation module is configured to receive 2D image data and the depth information data and generate the stereoscopic image data.

4. The apparatus of claim 1, wherein the parallax calculation unit comprises:
a stereo image parallax analysis module configured to analyze parallax information of the 3D image from a maximum parallax value (Max) to a minimum parallax value (Min) from the stereoscopic image data;
a depth information parallax analysis module configured to analyze parallax information of the 3D image from the depth information data; and
a parallax information clustering module configured to cluster the analyzed parallax information using a clustering algorithm.

5. The apparatus of claim 4, wherein the parallax information clustering module is configured to divide the parallax information step by step according to parallax generation distribution and determine the parallax step information.

6. The apparatus of claim 1, wherein the caption and text generation unit is configured to apply a parallax value to the caption and text inserted into the 3D image using the parallax step information and generate a caption and a text corresponding to a left-view image and a caption and a text corresponding to a right-view image through application of the parallax value.

7. The apparatus of claim 6, wherein the parallax value is automatically set according to the parallax step information, a setting determined by default during system design is used, or the parallax value is adjusted according to selection of a user watching the 3D image.

8. The apparatus of claim 1, wherein the caption and text generation unit is configured to identify a predetermined object within the stereoscopic image according to the analyzed parallax information and designate an insertion position of a caption and a text inserted into the stereoscopic image by considering the object.

9. The apparatus of claim 1, wherein the caption and text generation unit is configured to generate the caption and text using predetermined position information comprising pixel information, text font size information, and the parallax information and update the pixel information, the text font size information, and the parallax information at the request of a user watching the 3D image and of the system.

10. The apparatus of claim 1, wherein the caption and text generation unit is configured to generate a parallax of the caption and text using the parallax step information and, when the parallax of the caption and text is above a predetermined maximum parallax value, set the parallax of the caption and text as the predetermined maximum parallax value.

11. The apparatus of claim 10, wherein the caption and text generation unit is configured to generate position information of the caption and text so as to avoid insertion of the caption and text into a predetermined object part within the 3D image and an area above the maximum parallax value of the caption and text.

12. The apparatus of claim 1, wherein the caption and text generation unit is configured to receive caption and text parallax correction information based on watching environments of a user watching the 3D image and generate the caption and text and position information of the caption and text by considering the received caption and text parallax correction information.

13. The apparatus of claim 1, wherein the image synthesis unit is configured to insert the caption and text into the stereoscopic image data using a parallax value of the parallax step information as position information of the caption and text.

14. A method for providing image data in an image system, comprising:
receiving left-view image data and right-view image data and 2D image data and depth information data and generating stereoscopic image data;
analyzing parallax information of a 3D image from the stereoscopic image data and the depth information data, dividing the analyzed parallax information step by step according to parallax generation distribution by clustering the analyzed parallax information through a clustering algorithm, and determining parallax step information through the step-by-step division;
applying a parallax value to a caption and a text inserted into the 3D image using the parallax step information and generating a caption and a text corresponding to a left-view image, a caption and a text corresponding to a right-view image, and position information of the captions and texts through application of the parallax value; and
inserting the captions and texts into the stereoscopic image data using a parallax value of the parallax step information as the position information of the captions and texts and providing 3D image data.

15. The method of claim 14, wherein the parallax value is automatically set according to the parallax step information, a setting determined by default during system design is used, or the parallax value is adjusted according to selection of a user watching the 3D image.

16. The method of claim 14, wherein in said applying a parallax value to a caption and a text inserted into the 3D image using the parallax step information and generating a caption and a text corresponding to a left-view image, a caption and a text corresponding to a right-view image, and position information of the captions and texts through application of the parallax value,
a predetermined object within the stereoscopic image is identified according to the analyzed parallax information, and an insertion position of a caption and text inserted into the stereoscopic image is designated by considering the object.

17. The method of claim 14, wherein in said applying a parallax value to a caption and a text inserted into the 3D image using the parallax step information and generating a caption and a text corresponding to a left-view image, a caption and a text corresponding to a right-view image, and position information of the captions and texts through application of the parallax value,
the caption and text are generated using predetermined position information comprising pixel information, text font size information, and the parallax information, and the pixel information, the text font size information, and the parallax information are updated at the request of a user watching the 3D image and of the system.

18. The method of claim 14, wherein in said applying a parallax value to a caption and a text inserted into the 3D image using the parallax step information and generating a caption and a text corresponding to a left-view image, a caption and a text corresponding to a right-view image, and position information of the captions and texts through application of the parallax value,
a parallax of the caption and text is generated using the parallax step information and, when the parallax of the caption and text is above a predetermined maximum parallax value, the parallax of the caption and text is set as the predetermined maximum parallax value.

19. The method of claim 18, wherein in said applying a parallax value to a caption and a text inserted into the 3D image using the parallax step information and generating a caption and a text corresponding to a left-view image, a caption and a text corresponding to a right-view image, and position information of the captions and texts through application of the parallax value,
the position information of the caption and text is generated so as to avoid insertion of the caption and text into a predetermined object part within the 3D image and an area above the maximum parallax value of the caption and text.

20. The method of claim 14, wherein in said applying a parallax value to a caption and a text inserted into the 3D image using the parallax step information and generating a caption and a text corresponding to a left-view image, a caption and a text corresponding to a right-view image, and position information of the captions and texts through application of the parallax value,
caption and text parallax correction information based on watching environments of a user watching the 3D image is received, and the captions and texts and position information of the captions and texts are generated by considering the received caption and text parallax correction information.
